(19) United States
(12) Patent Application Publication
(10) Pub. No.: US 2019/0317442 A1
(43) Pub. Date: Oct. 17, 2019

(54) IMAGE FORMING APPARATUS

(71) Applicant: Konica Minolta, Inc., Tokyo (JP)

(72) Inventors: Kazunori NISHINOUE, Tokyo (JP); Toshihiro WAZUMI, Tokyo (JP); Motoki HIRONAKA, Tokyo (JP)

(21) Appl. No.: 16/288,390

(22) Filed: Feb. 28, 2019

(30) Foreign Application Priority Data
Apr. 13, 2018 (JP) 2018-077346

(51) Int. Cl. G03G 15/00; G03G 15/20

(52) U.S. Cl. CPC G03G 15/553; G03G 15/2039

(57) ABSTRACT

An image forming apparatus includes: an image former that forms a toner image on a recording material; a fixing device that pressurizes and heats the toner image formed on the recording material by the image former to be fixed on the recording material; and a hardware processor that estimates a remaining life of a predetermined fixing member on the basis of a temperature history in a temperature control period including a non-sheet passage time of the fixing member that forms a fixing nip in the fixing device and is raised in temperature and rotated.

The entire disclosure of Japanese patent Application No. 2018-077346, filed on Apr. 13, 2018,is incorporated herein by reference in its entirety.

### BACKGROUND

### Technological Field

The present invention relates to an image forming apparatus having a function to estimate a remaining life of a fixing member forming a fixing device.

### Description of the Related art

Conventionally, a remaining life of each fixing member (such as a roller/belt) used in a fixing device of an image forming apparatus has been estimated on the basis of the number of passed sheets of the main apparatus.

For example, there is an image forming apparatus that performs weighting according to a sheet passage mode or a sheet passage state and counts the number of passed sheets in determining a remaining life of a fixing device on the basis of the number of passed sheets (see JP 2000-131978 A).

Further, there is an image forming apparatus that determines a remaining life of a fixing device on the basis of the temperature of the fixing device and the time in which recording sheets have passed through the fixing device (see JP 2016-90830 A).

Conventionally (including the technologies disclosed in JP 2000-131978 A and JP 2016-90830 A), the remaining life has been estimated on the basis of the number of passed sheets, and the time and the temperature during sheet passage, and a replacement time of the fixing member has been notified to a user, but estimation accuracy has not been favorable. That is, there has been a problem that parts of the fixing device deteriorate despite the number of passed sheets having not reached the end of life and troubles occur in some cases depending on a use situation, it takes time to arrange the parts due to the sudden occurrence of troubles, and the apparatus cannot be used for a long time. Further, on the contrary, arrival of the replacement time of parts has been determined despite being still in a usable state, and wasteful cost has been incurred in some cases.

### SUMMARY

The present invention solves the above problems, and an object of the present invention is to provide an image forming apparatus capable of accurately estimating a remaining life of a fixing member included in a fixing device.

To achieve the abovementioned object, according to an aspect of the present invention, an image forming apparatus reflecting one aspect of the present invention comprises:

an image former that forms a toner image on a recording material;

a fixing device that pressurizes and heats the toner image formed on the recording material by the image former to be fixed on the recording material; and

a hardware processor that estimates a remaining life of a predetermined fixing member on the basis of a temperature history in a temperature control period including a non-sheet passage time of the fixing member that forms a fixing nip in the fixing device and is raised in temperature and rotated.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating a schematic configuration of an image forming apparatus according to an embodiment of the present invention;

FIG. 2 is a diagram illustrating a schematic configuration of a fixing device included in the image forming apparatus according to the embodiment of the present invention;

FIG. 3 is a graph illustrating a relationship between a time to when floating occurs in a PFA tube in a surface layer, and a temperature, in a case where a fixing belt is left in a high-temperature environment;

FIG. 4 is a diagram illustrating an example of a relationship between a lighting rate and a subtraction coefficient;

FIG. 5 is a diagram illustrating an example of a relationship between a rotation speed of a fixing member and a subtraction coefficient;

FIG. 6 is a diagram illustrating an example of a relationship between presence or absence of sheet passage and a subtraction coefficient;

FIG. 7 is a diagram illustrating an example of a relationship between a type of a sheet and a subtraction coefficient;

FIG. 8 is a diagram illustrating an example of a relationship between a sheet basis weight and a subtraction coefficient; and

FIG. 9 is a flowchart illustrating processing performed by a remaining life estimator of a controller of the image forming apparatus.

### DETAILED DESCRIPTION OF EMBODIMENTS

Hereinafter, one or more embodiments of the present invention will be described with reference to the drawings. However, the scope of the invention is not limited to the disclosed embodiments.

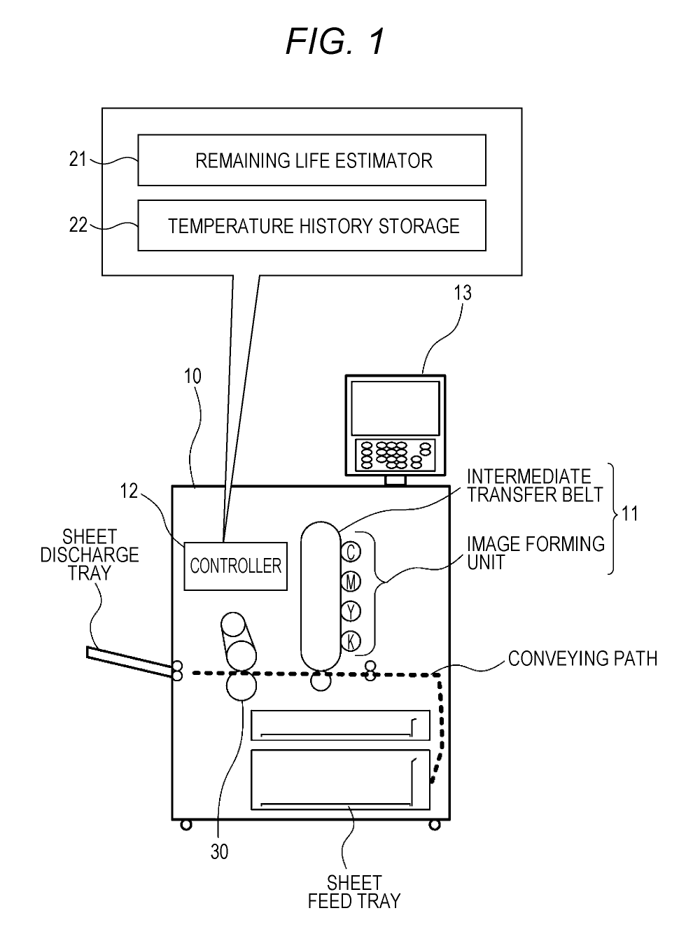

FIG. 1 is a diagram illustrating a schematic configuration of an image forming apparatus 10 according to an embodiment of the present invention. The image forming apparatus 10 has a function to print an image on a recording material such as recording sheet, a film, or cloth and output the image. The image forming apparatus 10 includes an image former 11 including an intermediate transfer belt stretched in an endless loop manner and image forming units of C, M, Y, and K colors arranged along the intermediate transfer belt, and superimposes toner images in C, M, Y, and K colors on the intermediate transfer belt by the image forming units to form a full-color toner image. Then, the image forming apparatus transfers the toner image formed on the intermediate transfer belt onto a sheet conveyed from a sheet feed tray, and pressurizes and heats the sheet by a fixing device 30 to fix the toner image on the sheet, and then outputs the sheet toward a sheet discharge tray. The method of the image forming apparatus 10 is not limited to the above-described tandem-type electrophotographic method, and any image forming method may be used as long as the method requires fixing processing by pressure and heating.

The image forming apparatus 10 includes a controller 12 that controls the operation of each unit. The controller 12 includes a central processing unit (CPU), a read only memory (ROM), a random access memory (RAM), a nonvolatile memory, a network communicator, and the like as main parts. The controller 12 controls the operation of the image forming apparatus 10 by the CPU executing a program stored in the ROM or the like.

Further, the image forming apparatus 10 includes an operation panel 13 serving a function to receive various operations from an operator and a function to display a setting screen/operation screen, a device state, warning, and the like.

The controller 12 of the image forming apparatus 10 executes a program to serve functions of a remaining life estimator 21, a temperature history storage 22, and the like. The remaining life estimator 21 serves a function to estimate a remaining life of each fixing member forming the fixing device 30 and determine a replacement time of the fixing member. The temperature history storage 22 serves a function to store a temperature history of the fixing member.

Note that the controller 12 controls the entire operation in forming an image on the recording material and controls the temperature of the fixing device 30. In a temperature control period, the controller 12 controls a heater 33 described below (controls a lighting rate or the like) to achieve a set fixing set temperature. The controller 12 controls the temperature of the fixing device 30 on a constant basis while the image forming apparatus 10 is powered on, or turns the fixing device 30 off in a power saving mode and controls the temperature of the fixing device 30 only during a period other than the power saving mode.

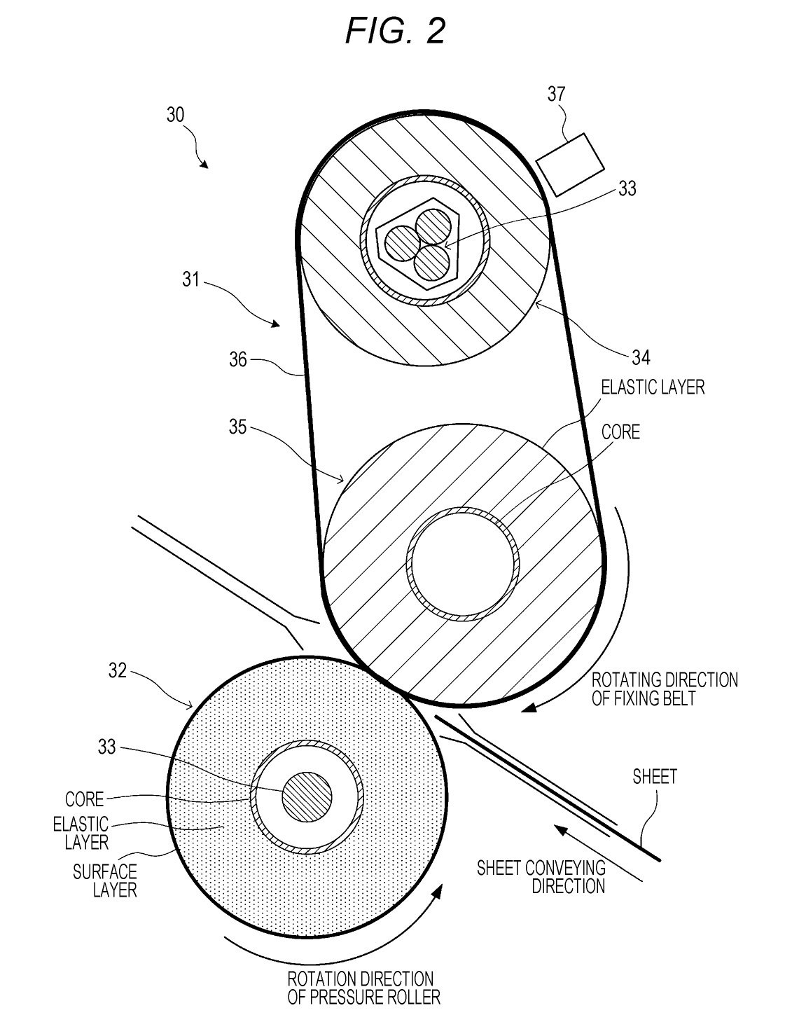

FIG. 2 illustrates a schematic configuration of a fixing device 30. The fixing device 30 mainly includes a fixing belt unit 31 including a heater 33, a heating roller 34, a fixing roller 35, a fixing belt 36, and the like, and a pressure roller 32. The fixing device 30 further includes a temperature sensor 37 that measuring a temperature of the fixing belt 36.

The fixing belt 36 is stretched over the heating roller 34 and the fixing roller 35 to enclose the heating roller 34 and the fixing roller 35. The heating roller 34 has a hollow center portion in which the heater 33 is arranged. Similarly, the pressure roller 32 has a hollow center portion in which the heater 33 is arranged. Here, a halogen lamp is used as the heater 33, but the heater 33 is not limited thereto.

The pressure roller 32 is driven to rotate by a motor (not illustrated), and the fixing roller 35 and the pressure roller 32 rotate following the pressure roller 32 via the fixing belt 36 pressed with the rotation of the pressure roller 32. The pressure roller 32 is pressed against the fixing roller 35 across the fixing belt 36 at least during sheet passage. The sheet passes through a portion where the pressure roller 32 and the fixing belt 36 are pressed in contact with each other while being nipped between the pressure roller 32 and the fixing belt 36.

The fixing belt 36 is formed such that an elastic layer made of silicone rubber or the like is formed on a base material made of a polyimide resin (PI) or the like, and a surface layer made of a polytetrafluoroethylene (PFA) (trifluoroethylene resin) tube or the like is further formed on the base material.

The fixing roller 35 is formed by a hollow or solid cylindrical core made of aluminum, iron, stainless steel material (SUS), or the like, and silicone rubber or silicone sponge forming an elastic layer around the core.

The pressure roller 32 is formed by a hollow cylindrical core made of aluminum, iron, SUS, or the like, an elastic layer made of silicone rubber or the like around the core, and a surface layer formed of a PFA tube or the like formed on the elastic layer. In the pressure roller 32 and the heating roller 34, the heater 33 is arranged in the core.

The life of the fixing members (the pressure roller 32, the fixing roller 35, and the fixing belt 36) forming a fixing nip is mainly determined by the following two points.

(1) Abrasion of Surface Layer Due to Sheet Passage and the Like

The surface layer is formed of a PFA tube or fluorine coat. The surface layer deteriorates as abrasion progresses mainly due to contact with an end face of a sheet, and the surface layer causes poor image quality as toner releasability of the surface layer deteriorates.

(2) Thermal Deterioration of Elastic Layer

Silicone rubber is mainly used for the elastic layer. Silicone rubber is cured by aged deterioration due to a thermal load. Adhesive strength between the elastic layer and the surface layer decreases due to the curing, causing surface layer floating (PFA tube floating) and elastic layer rupture due to reduction of elasticity.

In the case of the fixing device 30 illustrated in FIG. 2, the surface layers of the fixing belt 36 and the pressure roller 32 deteriorate due to sheet passage. Further, since all the three components of the fixing belt 36, the fixing roller 35, and the pressure roller 32 are heated to a high temperature during temperature control of the fixing device 30, thermal deterioration occurs.

Conventionally, roller/belt fixing systems having no slider determine a remaining life (replacement time) of the fixing member on the basis of the number of passed sheets, mainly focusing on surface layer abrasion due to the sheet passage of the above (1), and have not taken into account the thermal deterioration of (2), in particular, thermal deterioration at non-sheet passage time. Therefore, the estimation accuracy of the remaining life of the fixing member has not been sufficient, the fixing member has deteriorated before replacement indication has come out and a trouble has occurred, or a sign of replacement has come out despite being in a usable state, and wasteful cost has been incurred in some cases.

A factor of trouble due to floating of the PFA tube before the number of passed sheets set for the end of life arrives is considered to be thermal deterioration of the elastic layer. Therefore, the image forming apparatus 10 according to an embodiment of the present invention estimates a remaining life of the fixing member, considering the thermal deterioration of the above (2). In particular, the image forming apparatus 10 determines the remaining life of the fixing member on the basis of the temperature history in the temperature control period including the non-sheet passage time.

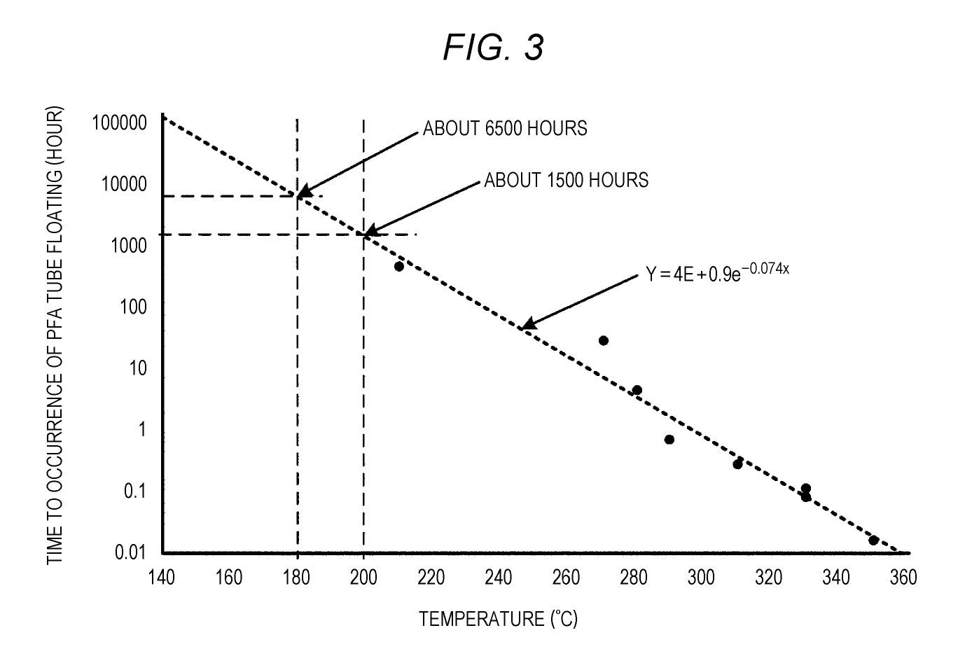

FIG. 3 illustrates a relationship between a time to when floating occurs in a PFA tube in a surface layer and a temperature, in a case where the fixing belt 36 is left in a high-temperature environment. The graph in FIG. 3 is approximately obtained on the basis of experimental data of a plurality of times of experiments. From the graph in FIG. 3, it can be seen that floating of the PFA tube occurs in 6500 hours in the environment of 180° C., whereas floating of the PFA tube occurs in 1500 hours in the environment of 200° C. That is, it can be seen that the life of the fixing member varies depending on the temperature.

From the graph in FIG. 3, the relationship between a temperature x and a life y is approximated by:

y=4E+0.9e^{-0.074x} (Expression 1).

The time (lifetime) to when the life of the fixing member ends due to thermal deterioration is obtained as follows on the basis of FIG. 3 and the above calculation expression.

The life (lifetime) of the fixing belt in a case where the reference temperature is 180° C. is 6500 hours. Therefore, when the total of time in which the temperature of the fixing belt 36 is controlled to 180° C. reaches 6500 hours, the life can be determined to have ended. When a fixing temperature is set to be high depending on a use situation, the thermal deterioration progresses correspondingly and thus the lifetime becomes short. For example, in the case of 200° C., the lifetime of the fixing belt 36 becomes 1500 hours and the life reaches end in 1/4.4 hours the lifetime (6500 hours) in the case of 180° C.

A correction efficient at 200° C. can be derived from

y(180)/y(200)=4.4

where the life at 180° C. is y (180) and the life at 200° C. is y (200), and the correction coefficient at each temperature can be similarly calculated.

For example, in a case of staying at 180° C. for 10 hours, the life of the fixing belt 36 is reduced from 6500 hours by 10 hours to 6490 hours regardless of sheet passage. Further, in a case of staying at 200° C. for 10 hours, 10 hours is multiplied by the correction coefficient (4.4), so that the life of the fixing belt 36 becomes

6500 hours−(10×4.4) hours=6456 hours.

The temperature history storage 22 of the image forming apparatus 10 has a record of a temperature history including a set value of the fixing temperature (fixing set temperature), and information of time in which the temperature of the fixing device 30 has been controlled at the set value, in a nonvolatile memory or the like on a constant basis. The image forming apparatus 10 corrects each time indicated by the recorded temperature history with the correction coefficient corresponding to the fixing set temperature set at the each time, and cumulatively subtracts the corrected time from the lifetime, thereby to calculate a remaining lifetime of a fixing part.

The image forming apparatus 10 notifies a user of the replacement time of the fixing part on the basis of the calculated remaining lifetime. For example, the image forming apparatus 10 notifies the user by displaying the remaining lifetime on the operation panel 13, or displaying arrival (or approaching) of the replacement time of the fixing part on the operation panel 13 when the remaining lifetime falls below a predetermined threshold value. The image forming apparatus 10 instructs the user to replace the fixing part when the calculated remaining lifetime becomes 0 or less.

Since the above-described (Expression 1) depends on the material, the size, and the like of the elastic layer and the surface layer of the fixing member, Expression 1 becomes a different expression for each type of the fixing member. That is, the expression regarding the fixing belt 36, the expression regarding the fixing roller 35, and the expression regarding the pressure roller 32 are individually separated.

The image forming apparatus 10 calculates the remaining lifetime for an individual fixing member, such as the fixing belt 36, the fixing roller 35, or the pressure roller 32. Favorably, the image forming apparatus 10 calculates the remaining lifetime for all the fixing members forming the fixing nip, and notifies the user of the replacement time for each fixing member. In a case where the unit of parts replacement is the fixing device 30, for example, the remaining lifetime is simply calculated for only the fixing member that causes the thermal deterioration at the earliest time in the replacement unit.

In the above-described example, the fixing set temperature and the time in which the temperature has been controlled at the fixing set temperature have been recorded as the temperature history. However, the temperature detected by the temperature sensor 37 may be used in place of the fixing set temperature. That is, the temperature detected by the temperature sensor 37 and the time in which the temperature has continued may be recorded as the temperature history.

Next, a case of calculating the remaining lifetime, further considering other factors related to thermal deterioration will be described.

One of the factors related to thermal deterioration is a lighting rate of the heater 33. Even when the fixing set temperature is the same, the lighting rate of the heater 33 becomes high in a case where the ambient environmental temperature is low or immediately after the power supply of the apparatus is turned on. Further, after a temperature raising state continues for a long time from the power on, the lighting rate is low because the surroundings are sufficiently warm, as compared to immediately after the power on.

Then, a heat supply amount to the fixing member becomes larger as the lighting rate of the heater 33 (here, a halogen lamp is used) is higher. That is, the lighting rate of the heater 33 influences the degree of thermal deterioration of the fixing member, and the thermal deterioration is promoted as the lighting rate is higher.

Therefore, a function to store the lighting rate of the heater 33 is provided in the image forming apparatus 10, and a subtraction coefficient is changed according to the lighting rate of the heater 33. For example, the lighting rate is recorded together with the temperature history. Specifically, the fixing set temperature (or the temperature detected by the temperature sensor 37) and the information of the time in which the temperature has been controlled at the fixing set temperature, and the lighting rate at the time are recorded, and a time obtained by the following expression is subtracted from the lifetime:

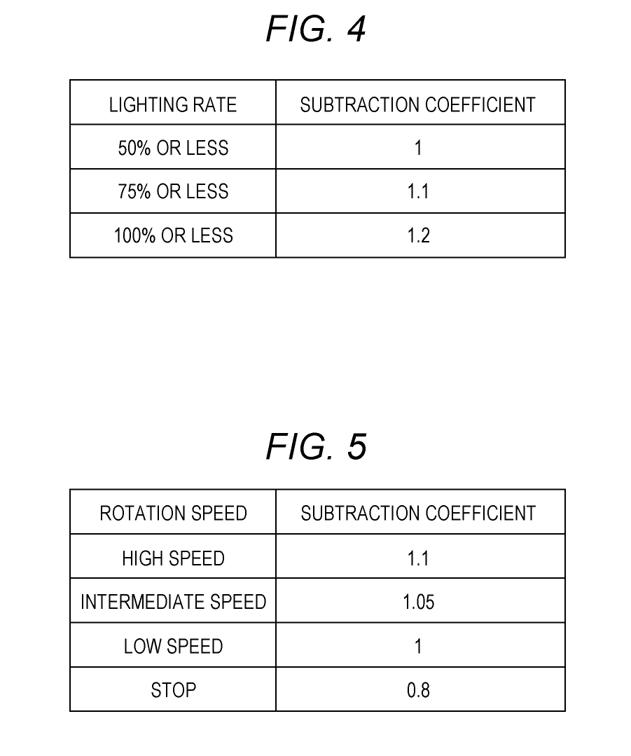

a time×the correction coefficient corresponding to the temperature at the time×the subtraction coefficient corresponding to the lighting rate at the time. FIG. 4 illustrates an example of a relationship between the lighting rate and the subtraction coefficient. Since the thermal load to the life becomes larger as the lighting rate is higher, the subtraction coefficient is made large.

Further, it is known that the lighting rate of the heater 33 changes depending on factors such as a rotation speed of the fixing member/presence or absence of sheet passage/a basis weight of a passed sheet/a type of the sheet. Therefore, in a case where the function to record the lighting rate is not provided, the subtraction coefficient may be set on the basis of the above factors in place of the lighting rate.

Specifically, since the thermal load to the life increases as the rotation speeds of the fixing roller 35 and the pressure roller 32 are faster, the subtraction coefficient is made large (see FIG. 5).

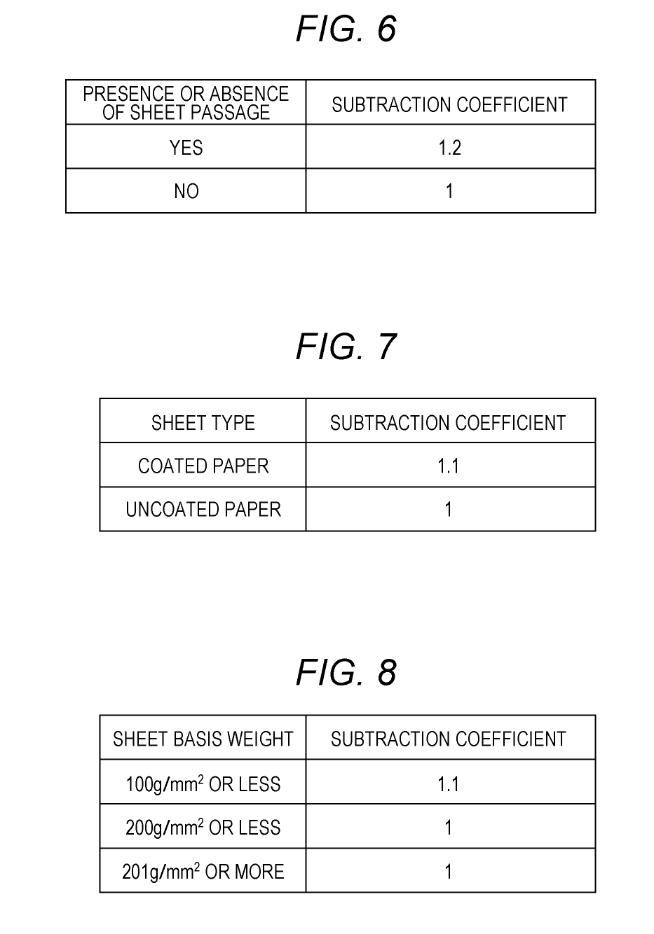

Since the thermal load increases at the sheet passage time as compared with at the non-sheet passage time regarding the presence or absence of sheet passage, the subtraction coefficient is made large (see FIG. 6).

As for the sheet, the subtraction coefficient is made larger as the sheet has a larger thermal capacity. Specifically, in a case of correcting the time regarding the temperature history in a period during sheet passage, the subtraction coefficient is made larger in a case where the sheet type is coated paper than a case where the sheet type is uncoated paper (see FIG. 7). Regarding the basis weight of the sheet, the subtraction coefficient is made larger as the basis weight is larger (see FIG. 8). Regarding the temperature history at the non-sheet passage, correction with the subtraction coefficient on the basis of the sheet type or the basis weight is not performed.

The subtraction coefficient may be determined in combination of a plurality of the above factors. The information regarding the rotation speed of the fixing member/the presence or absence of sheet passage/the basis weight of a passed sheet/the type of the sheet may just be recorded together with the temperature history, similarly to the lighting rate. For example, the fixing set temperature (or the temperature detected by the temperature sensor 37) and the information of the time in which the temperature has been controlled at the fixing set temperature, and the rotation speed of the fixing member at the time are recorded, and a time obtained by the following expression is subtracted from the lifetime:

a time×the correction coefficient corresponding to the temperature at the time×the subtraction coefficient corresponding to the rotation speed at the time.

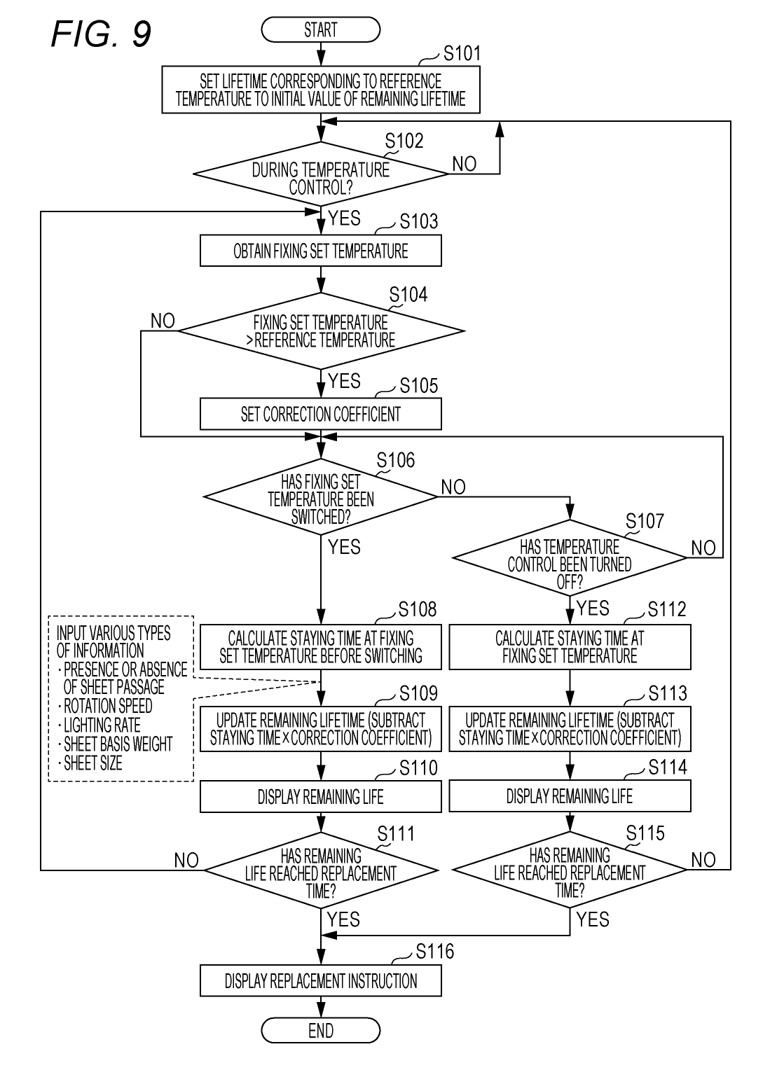

FIG. 9 is a flowchart illustrating processing performed by the remaining life estimator 21 of the controller 12 of the image forming apparatus 10. First, the lifetime corresponding to the reference temperature (for example, 180° C.) is obtained and the lifetime is set to an initial value of the remaining lifetime (step S101). Next, whether the present time is in the temperature control period in which the temperature of the fixing device 30 is controlled is determined (step S102), and when the present time is not in the temperature control period (No in step S102), the temperature control period is waited.

When the present time is in the temperature control period (Yes in step S102), the controller 12 obtains the current fixing set temperature (step S103) and determines whether the fixing set temperature is higher than the reference temperature (for example, 180° C.) (step S104). When the fixing set temperature is higher than the reference temperature (Yes in step S104), the correction coefficient corresponding to the fixing set temperature is set (step S105), and the processing moves onto step S106. When the fixing set temperature is not higher than the reference temperature (No in step S104), the correction coefficient is set to default “1”, and the processing moves onto step S106.

In step S106, whether the fixing set temperature has been switched is determined, and when there is no switching of the fixing set temperature (No in step S106), whether the temperature control of the fixing device 30 has been turned off (whether the present time is not in the temperature control period) is determined (step S107). When the temperature control of the fixing device 30 is not off (No in step S107), the processing returns to step S106 and continues.

Note that the image forming apparatus 10 switches the fixing set temperature for each job according to the sheet to be used. Further, when one job is completed and there is no next job, the fixing set temperature is changed to a slightly low temperature for standby. Further, the temperature control of the fixing device 30 is turned off when the power supply is off or during the power saving mode.

When the fixing set temperature has been switched (Yes in step S106), a staying time at the fixing set temperature before switching is calculated (step S108), a time obtained by multiplying the staying time by the previously obtained correction coefficient is calculated, and the time is subtracted from the remaining lifetime to update the remaining lifetime (step S109). Note that the subtraction coefficient based on the lighting rate or the like may be further applied in calculating the time to be subtracted.

The image forming apparatus 10 displays the remaining lifetime obtained in step S109 on the operation panel 13 or the like, as needed such as a case where the remaining lifetime takes a certain value or less, for example (step S110). Further, whether the replacement time of the fixing part has arrived is determined on the basis of whether the remaining lifetime becomes the predetermined threshold value or less (step S111), and when the replacement time has not arrived (No in step S111), the processing returns to step S103 and continues. When the replacement time has arrived (Yes in step S111), the instruction of part replacement is displayed on the operation panel 13 or the like (step S116), and the present processing is terminated.

When the temperature control of the fixing device 30 has been turned off (Yes in step S107), the staying time at the fixing set temperature before off is calculated (step S112), a time obtained by multiplying the staying time by the previously obtained correction coefficient is calculated, and the time is subtracted from the remaining lifetime to update the remaining lifetime (step S113). Note that, at this time, the subtraction coefficient based on the lighting rate or the like may be further applied. For example, in a case where the temperature of the fixing device 30 has been controlled at a slightly low temperature after completion of a job but the processing moves onto the power saving mode because non-operation has continued, the determination is Yes in step S107.

The image forming apparatus 10 displays the remaining lifetime obtained in step S113 on the operation panel 13 or the like as needed (step S114). Further, whether the replacement time of the fixing part has arrived is determined on the basis of whether the remaining lifetime becomes the predetermined threshold value or less (step S115), and when the replacement time has not arrived (No in step S115), the processing returns to step S102 and waits for the time reaching the temperature control state again. When the replacement time has arrived (Yes in step SUS), the instruction of part replacement is displayed on the operation panel 13 or the like (step S116), and the present processing is terminated.

Although the embodiment of the present invention has been described with reference to the drawings, specific configurations are not limited to those described in the embodiment, and changes and additions without departing from the gist of the present invention are included in the present invention.

For example, in the processing in FIG. 9, the correction coefficient has been set to “1” in the case where the fixing set temperature is the reference temperature or less in step S104. However, the correction coefficient for the fixing set temperature may be obtained in a case where the fixing set temperature is lower than the reference temperature. In this case, the correction coefficient is a value of 1 or less (for example, 0.8 or the like).

Further, in the embodiment, the remaining lifetime of the fixing member has been calculated on the basis of the temperature history in all the temperature control period including the sheet passage time and the non-sheet passage time. However, the present invention is not limited to the embodiment, and the remaining life of the fixing member may be estimated on the basis of the temperature history in the temperature control period including at least the non-sheet passage time. For example, in a case where the fixing set temperature is lower than the reference temperature by a certain value or more even during the temperature control period of the non-sheet passage time, the fixing set temperature may be excluded from the temperature history. Further, determination of the remaining life according to the number of passed sheets and determination of the remaining life based on the temperature history may be used together. For example, even when the replacement time of a part is determined to have arrived from the remaining life based on the number of passed sheets, the replacement time may be determined not to have arrived yet in a case where the remaining life based on the temperature history still has a certain period or more.

Deterioration of the fixing member at the sheet passage is determined on the basis of the number of passed sheets and the degree of deterioration at the non-sheet passage time is obtained from the temperature history, and the replacement time of the fixing member may be determined by integrating the determination and obtainment. For example, in a case where deterioration based on the temperature history at the non-sheet passage time reaches a certain degree of deterioration or more, the replacement time may be determined to have arrived even if the number of passed sheets is smaller than the original number of sheets for the life.

According to an embodiment of the present invention, a remaining life of a fixing member of a fixing device can be more accurately estimated.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
an image former that forms a toner image on a recording material;
a fixing device that pressurizes and heats the toner image formed on the recording material by the image former to be fixed on the recording material; and
a hardware processor that estimates a remaining life of a predetermined fixing member on the basis of a temperature history in a temperature control period including a non-sheet passage time of the fixing member that forms a fixing nip in the fixing device and is raised in temperature and rotated.

2. The image forming apparatus according to claim 1, wherein
the hardware processor estimates the remaining life of the fixing member on the basis of the temperature history in all the temperature control periods including a sheet passage time and the non-sheet passage time.

3. The image forming apparatus according to claim 1, wherein
the hardware processor estimates the remaining life for each of the fixing members forming the fixing nip in the fixing device.

4. The image forming apparatus according to claim 1, wherein
the temperature history includes a set temperature in raising the temperature of the fixing member and a time in which the temperature of the fixing member has been controlled at the set temperature.

5. The image forming apparatus according to claim 1, wherein
the temperature history includes the temperature of the fixing member detected by a temperature sensor and a time in which the temperature is continued.

6. The image forming apparatus according to claim 1, wherein
the hardware processor sets a lifetime of the fixing member at a reference temperature, and estimates the remaining life of the fixing member by subtracting the lifetime on the basis of the temperature history.

7. The image forming apparatus according to claim 6, wherein
the hardware processor changes a correction coefficient for the remaining life of the fixing member at the reference temperature according to the temperature of the fixing member, corrects a time indicated by the temperature history, and subtracts the time from the lifetime.

8. The image forming apparatus according to claim 7, wherein
the hardware processor sets a subtraction coefficient according to a lighting rate of a heater that raises the temperature of the fixing member, and further corrects the time indicated by the temperature history with the subtraction coefficient.

9. The image forming apparatus according to claim 7, wherein
the hardware processor sets a subtraction coefficient according to a rotation speed of the fixing member, and further corrects the time indicated by the temperature history with the subtraction coefficient.

10. The image forming apparatus according to claim 7, wherein
the hardware processor sets a subtraction coefficient according to whether the temperature history is the temperature history in a period during sheet passage or is the temperature history in a period during non-sheet passage, and further corrects the time indicated by the temperature history with the subtraction coefficient.

11. The image forming apparatus according to claim 7, wherein
the hardware processor sets a subtraction coefficient according to a type of a sheet during sheet passage, for the temperature history in a period during sheet passage, and further corrects the time indicated by the temperature history with the subtraction coefficient.
